(19) United States
(12) Patent Application Publication
(10) Pub. No.: US 2021/0143662 A1
(43) Pub. Date: May 13, 2021

(54) CHARGING VOLTAGE REDUCTION OF BATTERIES

(71) Applicant: Hewlett-Packard Development Company, L.P., Spring, TX (US)

(72) Inventors: Jen-Hao Tai, Taipei City (TW); Chien-Kun Wang, Taipei City (TW); Chang-Tai Lin, Taipei City (TW); Xiao-Kai Mao, Taipei City (TW)

(73) Assignee: Hewlett-Packard Development Company, L.P., Spring, TX (US)

(21) Appl. No.: 16/978,732

(22) PCT Filed: Jul. 27, 2018
(86) PCT No.: PCT/US2018/043994

§ 371 Date: Sep. 7, 2020

(51) Int. Cl. H02J 7/00; H01M 10/48

(52) U.S. Cl. CPC H02J 7/007194; H01M 10/488

(57) ABSTRACT

In one example, an electronic device may include a battery, a measuring unit to record a plurality of temperature readings associated with an operation of the battery at particular time intervals, and a control unit coupled to the measuring unit. The control unit may retrieve a set of temperature readings corresponding to a period from the plurality of temperature readings, analyze the set of temperature readings corresponding to the period to determine whether a temperature of the battery exceeds a threshold, and reduce a charging voltage of the battery in response to a determination that the temperature of the battery exceeds the threshold.

### BACKGROUND

Portable electronic devices are becoming increasingly popular. Examples of portable electronic devices may include handheld computers (e.g., notebooks, tablets, and the like), cellular telephones, media players, and hybrid devices which include the functionality of multiple devices of this type. Such electronic devices may be powered by battery packs. The battery packs may include rechargeable batteries, such as Nickel batteries, Lithium batteries, and the like and are capable of providing power to the electronic devices, for instance, for several hours.

### BRIEF DESCRIPTION OF THE DRAWINGS

Examples are described in the following detailed description and in reference to the drawings, in which:

FIG. 1A is a block diagram of an example electronic device, including a control unit to reduce a charging voltage of a battery based on a set of temperature readings corresponding to a period;

FIG. 1B is a block diagram of the example electronic device of FIG. 1A, depicting additional features;

FIG. 2 is a block diagram of an example electronic device, including a control unit to reduce a charging voltage of a battery proportional to an amount of time a temperature of the battery is in a first temperature range;

FIG. 3A is an example table, depicting lifetime data including a plurality of temperature readings associated with an operation of a battery;

FIG. 3B is an example table, depicting a set of the temperature readings associated with the operation of the battery corresponding to a block or a period;

FIG. 3C is an example characteristics graph illustrating temperature versus voltage characteristics, depicting temperature changes over the period;

FIGS. 3D and 3E are example tables depicting reduction of a charging voltage of the battery proportional to an amount of time the temperature of the battery is in a high-temperature range and an over-temperature range, respectively; and

FIGS. 4A and 4B are block diagrams of an example electronic device including a non-transitory machine-readable storage medium, storing instructions to reduce a charging voltage of a battery pack.

### DETAILED DESCRIPTION

Rechargeable batteries may be used as a source of power to electronic devices. The rechargeable batteries, such as Nickel batteries, Lithium batteries, and the like, may be capable of providing power to the electronic devices for several hours. However, the rechargeable batteries may experience a performance degradation or even catastrophic failure when subject to elevated temperatures. For example, the elevated temperatures may lead to swelling of the batteries and minimize the life of the batteries.

Examples described herein may analyze temperature readings of a battery over a period to reduce a charging voltage of the battery. In one example, an electronic device may include a battery pack having a battery and a fuel gauge. The fuel gauge may record a plurality of temperature readings of the battery at particular time intervals. The measured plurality of temperature readings being segmented into a set of temperature ranges. The electronic device may include a control unit to determine an amount of time a temperature of the battery is in a first temperature range of the set of temperature ranges. The first temperature range may be greater than a threshold. Further, the control unit may reduce a charging voltage of the battery proportional to the amount of time the temperature of the battery is in the first temperature range. Thus, examples described herein may mitigate swelling and enhance the life of the battery pack.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

Turning now to the figures, FIG. 1A is a block diagram of an example electronic device 100, including a control unit 106 to reduce a charging voltage of a battery 102 based on a set of temperature readings corresponding to a period. Example electronic device 100 may represent, but is not limited to, a computer, a server, a notebook, a tablet, a monitor, a smart phone, a personal digital assistant, a kiosk, a television, a display, or a combination thereof. Example battery 102 may be a Nickel-based battery, Lithium-based battery, or the like.

Electronic device 100 may include battery 102, measuring unit 104 to record a plurality of temperature readings associated with an operation of battery 102 at particular time intervals, and control unit 106 coupled to measuring unit 104. Example control unit 106 may be an embedded controller. Example embedded controller may be an embedded keyboard controller. In some examples, the components of electronic device 100 may be implemented in hardware, machine-readable instructions, or a combination thereof. In one example, control unit 106 may be implemented as engines or modules comprising any combination of hardware and programming to implement the functionalities described herein.

During operation, control unit 106 may retrieve a set of temperature readings corresponding to a period from the plurality of temperature readings (i.e., statistical temperature readings). Consider an example, where the plurality of temperature readings may include temperature readings associated with a total runtime of battery 102, for instance, say 300 days (i.e., 300*24=7200 hours). In this example, each temperature reading may be recorded every 2 hours (i.e., a particular time interval). The term “total runtime” may refer to an overall runtime from beginning of the operation of battery 102 (e.g., the operation beginning within one month of manufacture) till the current time (e.g., till a last recorded temperature reading). In this example, the period may refer to recent 100 days (i.e., 100*24=2400 hours) and the set of temperature readings may include temperature readings corresponding to the recent 100 days. For example, the plurality of temperature readings corresponding to 300 days may include {R1, R2, . . . , Rn}, where R1 is the latest reading. The set of temperature readings corresponding to the recent 100 days may include {R1, R2, . . . , Rm}, where m<n. The plurality of temperature readings and the set of temperature readings may be explained using example FIGS. 3A and 3B, respectively.

Further, control unit 106 may analyze the set of temperature readings corresponding to the period (e.g., 100 days) to determine whether a temperature of battery 102 exceeds a threshold. For example, the threshold may be an indicative of a temperature level beyond which battery 102 may get affected. The threshold may be set based on a voltage specification (e.g., a capacity) of battery 102.

Furthermore, control unit 106 may reduce a charging voltage of battery 102 in response to a determination that the temperature of battery 102 exceeds the threshold. In one example, control unit 106 may, determine an amount of time the temperature of battery 102 exceeds the threshold based on the analysis of the set of temperature readings corresponding to the period. Then, control unit 106 may reduce the charging voltage of battery 102 corresponding to the determined amount of time the temperature of battery 102 exceeds the threshold. In some examples, control unit 106 may permanently reduce the charging voltage of battery 102. Thus, reducing the charging voltage may minimize battery swelling and enhances battery performance.

FIG. 1B is a block diagram of example electronic device 100 of FIG. 1A, depicting additional features, For example, similarly named elements of FIG. 1B may be similar in structure and/or function to elements described with respect to FIG. 1A. As shown in FIG 1B, measuring unit 104 may include a sensor 152 (e.g., a thermistor) to measure the plurality of temperature readings associated with the operation of battery 102 at the particular time intervals, a memory 154, and a processor 156 to store the plurality of temperature readings in memory 154. In some examples, measuring unit 104 may be implemented as a part of battery 102 or externally coupled to battery 102. For example, the temperature readings may be periodically detected and recorded by measuring unit 104 (e.g., as shown in FIG. 1B), or may be periodically detected and recorded by a fuel gauge on battery itself (e.g., as shown in FIG. 2).

Example electronic device 100 may further include a charger circuit 158 coupled to a power input and battery 102. The power input may include, for example, a circuit breaker or other current-limiting device, a filter, and/or a rectifier. Charger circuit 158 may include a power-control switch or switches, which can be controlled by control unit 106, Charger circuit 158 may convert, an input power to an output power to charge battery 102. For example charger circuit 158 may include a power input end to receive the input power from the power input and convert the input power into the output power, a power output end to output the output power to charge battery 102, and a control pin to receive the control signal to control the charging voltage of battery 102. In one example, control unit 106 may control the output power from charger circuit 158 to reduce the charging voltage of battery 102 in response to the determination that the temperature of battery 102 exceeds the threshold.

FIG. 2 is a block diagram of an example electronic device 200, including a control unit 210 to reduce a charging voltage of a battery 204 proportional to an amount of time a temperature of battery 204 is in a first temperature range. Example electronic device 200 may include a battery pack 202 including battery 204 and a fuel gauge 206. In some examples, battery pack 202 may include a plurality of batteries. In other examples, battery 204 may include, multiple cells. Fuel gauge 206 may measure a plurality of temperature readings of battery 204 at particular time intervals, Further, the measured plurality of temperature readings being segmented into a set of temperature ranges and stored in a memory associated with battery pack 202. In this example, fuel gauge 206 and the memory may be integral to battery pack 202.

In one example, fuel gauge 206 may be an integrated circuit including components to perform the functionalities described herein. Fuel gauge 206 may include, for example, a printed circuit board, a microelectronic chip, a wire or a related signal path, and/or any other type of electronic circuitry. Fuel gauge 208 may include components that measure, detect, monitor, and/or store temperature readings associated with battery 204. In some examples, fuel gauge 206 may produce data files containing the temperature readings and store in the memory.

For example, fuel gauge 206 may include a sensor to measure the plurality of temperature readings of battery 204 at the particular time intervals, the memory, and a processor to segment the measured plurality of temperature readings into the set of temperature ranges and store the segmented plurality of temperature readings in the memory. Example temperature readings may be computed as a part of lifetime data calculation of battery 204 at particular intervals (e.g., periodic intervals). Example lifetime data may include information associated with voltage, current, temperature, and the like.

Further, electronic device 200 may include a charger circuit 208 to charge battery 204. In one example, charger circuit 208 may convert an input power to an output power having a particular voltage value depending on a number and a type of batteries being charged and at a specified current rate. Furthermore, electronic device 200 may include control unit 210 communicatively coupled to fuel gauge 206. In one example, the components of electronic device 200 may be implemented in hardware, machine-readable instructions, or a combination thereof. In one example, control unit 210 may be implemented as engines or modules comprising any combination of hardware and programming to implement the functionalities described herein.

During operation, control unit 210 may access fuel gauge 206 to retrieve temperature readings (e.g., data files) stored therein, for instance, over a period, Furthermore, control unit 210 may analyze the temperature readings to determine an amount of time a temperature of battery 204 is in a first temperature range of the set of temperature ranges. The first temperature range may be greater than a threshold.

Furthermore, control unit 210 may reduce, via charger circuit 208, a charging voltage of battery 204 proportional to the amount of time the temperature of battery 204 is in the first temperature range. In one example, control unit 210 may determine a value of the charging voltage to be supplied to battery 204 based on the amount of time the temperature of battery 204 is in the first temperature range and reduce the charging voltage based on the determined value.

In other examples, control unit 210 may determine an amount of time the temperature of battery 204 is in a second temperature range of the set of temperature ranges. The second temperature range may be different from the first temperature range and greater than the threshold. In this example, control unit 210 may reduce the charging voltage of battery 204 proportional to the amount of time the temperature of battery 204 is in the first temperature range and the second temperature range. For example, the first temperature range can be 45° C. to 51° C. and the second temperature range can be higher than 51° C. or vice versa. In this example, the threshold may be 44° C.

In other examples, control unit 210 may generate an option to reduce a charging voltage of battery 204 on a display unit in response to determining the amount of time the temperature of battery 204 is in the first temperature range and reduce the charging voltage of battery 204 in response to a selection of the option. Example display may be a liquid crystal display (LCD), a light emitting diode (LED) display, an organic light emitting diode (OLED) display, a plasma display panel (PDP), an electro-luminescent (EL) display, or the like. Electronic device 200 may also be equipped with other components such as audio/video devices, keyboard, touchpad, sensors, and the like, depending on the functions of electronic device 200.

For example the set of temperature ranges may include an under-temperature range, a low-temperature range, a standard low-temperature range, a room-temperature range, a standard high-temperature range, a high-temperature range, and an over-temperature range. In this example, the set of temperature ranges can be classified as: under-temperature range<low-temperature range<standard low-temperature range<room-temperature range<standard high-temperature range<high-temperature range<over-temperature range.

In this example, consider that the high-temperature range and the over-temperature range may be greater than the threshold. The terms “high-temperature range” and “over-temperature range” may refer to temperature ranges which can affect the life span of battery 204. Hence, control unit 210 may determine an amount of time the temperature of battery 204 is in the over-temperature range (e.g., the first temperature range) and the high-temperature range (e.g., second temperature range). Further, control unit 210 may reduce the charging voltage of battery 204 proportional to the amount of time the temperature of battery 204 is in the high-temperature range and the over-temperature range. This is explained with an example in FIGS. 3A-3E.

The electronic device (e.g., electronic device 100 of FIGS. 1A and 1B or electronic device 200 of FIG. 2) may include computer-readable storage medium comprising (e.g., encoded with) instructions executable by a processor to implement functionalities described herein in relation to FIGS. 1 and 2. In some examples, the functionalities described herein, in relation to instructions to implement functions of components of electronic device 100 and 200 and any additional instructions described herein in relation to the storage medium, may be implemented as engines or modules comprising any combination of hardware and programming to implement the functionalities of the modules or engines described herein. The functions of components of electronic device 100 or 200 may also be implemented by a respective processor. In examples described herein, the processor may include, for example, one processor or multiple processors included in a single device or distributed across multiple devices.

FIG. 3A is an example table 300A, depicting lifetime data including temperature readings associated with an operation of a battery. Example lifetime data may include information associated with voltage, current, temperature, and the like. The term “lifetime” may refer to an operating time from beginning of the operation of the battery (e.g., beginning within one, month of manufacture) till the current time (e.g., a last recorded data). For example, the lifetime data may include data about a relationship between the temperature readings and time. The lifetime data may be available through manufacturer access commands or manufacturer block access commands (e.g., as shown in column 302). For example, manufacturer access commands may provide access to the lifetime data through a smart battery data set standard. When the lifetime data is in a sealed mode (e.g., as shown in column 304), the lifetime data can be accessed using a sequence of a manufacturer access write word command and a manufacturer data block read command. The manufacturer block access command may enable access to the same lifetime data, but through a simpler block write/read sequence (e.g., as shown in column 306) to the same command. For example, each block of data may refer to a period. In one example, manufacturer block access command (e.g., 0X0062) may read lifetime data (i.e., a set of temperature readings) at block 3 (e.g., a period).

FIG. 38 is an example table 3008, depicting a set of the temperature readings associated with the operation of the battery corresponding to a block or period (e.g., block 3). In this example, lifetime data values corresponding to temperature readings may be outputted corresponding to block 3 using, for instance, the manufacturer block access command. In some examples, a fuel gauge may record the temperature readings at different time intervals (e.g., periodic time intervals) and the recorded temperature readings may be segmented into several temperature ranges. A control unit may access the fuel gauge to retrieve a set of temperature readings corresponding to block 3. Example table 300B may depict a value 308 and a time 310 corresponding to block 3. For example, time 310 may represent a total battery runtime and a time spent in each temperature range during an operation of the battery, For example, value “AAaa” may indicate a total battery runtime, value “BBbb” may indicate a time spent in an under-temperature range, value “GGgg” may indicate a time spent in a high-temperature range, value “HHhh” may indicate a time spent in an over-temperature range and the like.

FIG. 3C is a characteristics graph 300C illustrating temperature versus cell voltage characteristics, depicting temperature changes over the period. Characteristics graph 300C may include an x-axis representing the temperature readings at time intervals T1 to T6 and a y-axis representing a battery voltage/cell voltage. Particularly, characteristics graph 300C may illustrate temperature versus cell voltage characteristics corresponding to the set of temperature readings associated with block 3. As shown in FIG. 3C, the temperature of the battery is in a high-temperature range between time intervals T3 and T4 (e.g., as shown in 312). In one example, high-temperature data and over-temperature data may be used to adjust the charging voltage as shown in FIGS. 3D and 3E.

FIGS. 3D and 3E are example tables 300D and 300E depicting reduction of a charging voltage of the battery proportional to an amount of time the temperature of the battery is in a high-temperature range and an over-temperature range, respectively, Upon determining that the temperature of the battery is in the high-temperature range between time intervals T3 and T4, the amount of time the temperature of the battery is in the high-temperature range can be calculated. Further, the charging voltage of the battery may be reduced proportional to the calculated amount of time the temperature of the battery is in the high-temperature range. Particularly, table 300D depicts a time spent in high-temperature range 314, a charging voltage 316 corresponding to the time spent in high-temperature range 314, and a state of charge (SoC) 318 corresponding to charging voltage 316.

For example, consider a full capacity SoC of the battery with charging voltage of 4400 millivolts (mV) is 100%, which can support 90 days in a 45° C. environment (e.g., the temperature less than the threshold). As shown in FIGS. 3D and 3E, when the temperature of the battery is not in the high-temperature range and/or over-temperature range, then the charging voltage may not be reduced. In this case, the SoC is 100%, As shown in table 300D, when the temperature of the battery is in the high-temperature range for 20 days, the charging voltage can be reduced by 0.05V to 4350 mV. In this example, the SoC is 95%. When the high-temperature is accumulated over 80 days, then the charging voltage can be reduced by a maximum of 0.2V to 4200 mV as shown in table 300D of FIG. 3D. In this example, the SOC is 80%.

Similarly, when the temperature of the battery is in the over-temperature range, the amount of time the temperature of the battery is in the over-temperature range can be used to reduce the charging voltage of the battery. Table 300E depicts a time spent in over-temperature range 320, a charging voltage 322 corresponding to the time spent in over-temperature range 320, and a state of charge 324 corresponding to charging voltage 322.

As shown in table 300E, when the temperature of the battery is in the over-temperature range for 10 days, the charging voltage can be reduced by 0.1V to 4300 mV. In this example, the SoC is 90%. When the over-temperature is accumulated over 20 days, then the charging voltage can be reduced by a maximum of 0.2V to 4200 mV. In this example, the SoC is 80%. In some examples, reducing the charging voltage by 0.05V may impact the capacity of the battery (e.g., SoC) by about 5%, however, minimizes/mitigates battery pack swelling and enhances the battery life. Further, the cost of replacing battery can be saved, thus improving the user experience.

FIGS. 4A and 4B are block diagrams of an example electronic device 400 including a non-transitory computer-readable storage medium, storing instructions to reduce a charging voltage of a battery pack. Electronic device 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), rambus DRAM (RDRAM) rambus RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage, medium 404 may be remote but accessible to electronic device 400.

As shown in FIG. 4A, machine-readable storage medium 404 may store instructions 406-412. As shown in FIG. 4B, machine-readable storage medium 404 may store instructions 406-414. In an example, instructions 406-414 may be executed by processor 402 to reduce the charging voltage of the battery pack. For example. the battery pack may include a battery or a plurality of batteries. Instructions 406 may be executed by processor 402 to retrieve a set of temperature readings corresponding to a period from the battery pack. The set of temperature readings may fall into, discrete temperature ranges. For example, a plurality of temperature readings (e.g., lifetime data) associated with an operation of the battery pack at particular time intervals may be monitored and stored via a fuel gauge resided in the battery pack. In this example, the set of temperature readings corresponding to the period may be retrieved from the plurality of temperature readings.

Instructions 408 may be executed by processor 402 to analyze the set of temperature readings corresponding to the period. Instructions 410 may be executed by processor 402 to determine an amount of time a temperature of the battery pack is in a first temperature range of the discrete temperature ranges based on the analysis. The first temperature range may be greater than a threshold.

Instructions 412 may be executed by processor 402 to generate an option to reduce the charging voltage of the battery pack on a display unit in response to determining the amount of time the temperature of the battery pack is in the first temperature range. In one example, a value of the charging voltage to be supplied to the battery pack may be determined based on the amount of time the temperature of the battery pack is in the first temperature range. Then, the option including the determined value may be generated on the display unit.

As shown in FIG. 4B, instructions 414 may be executed by processor 402 to reduce the charging voltage of the battery pack in response to a selection of the option. In one example, instructions 414 may be executed by processor 402 to reduce the charging voltage of the battery pack corresponding to the determined amount of time the temperature of the battery pack is in the first temperature range by generating a command to a charger circuit that supplies the charging voltage to the battery pack.

In other examples, the battery pack may include multiple cells. In such examples, a set of temperature readings may be collected and analyzed for a specific type of cell in the battery pack. In some other examples, an ambient temperature or environment temperature surrounding the battery pack can also be used along with the temperature of the battery pack to adjust the charging voltage.

Examples described herein may be implemented for charging batteries of portable electronic devices, such as notebook computers, cellular phones, personal digital assistants, MP3 players, cameras, medical devices, computer peripherals, and the like. In addition to portable electronic devices, examples described herein may be implemented in any other type of electronic device that is partially or fully battery powered and has an electronic circuitry that is coupled to receive power from a battery system. Therefore, examples described herein may be implemented in portable or non-portable (e.g., server backup battery) system applications where smart batteries can be employed.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based, on some stimulus can be based on the stimulus or a combination of stimuli including the stimulus.

The present description has been shown and described with reference to the foregoing examples, it is understood, however, that other forms, details, and examples can be made without departing from the spirit and scope of the present subject matter that is defined in the following claims.

What is claimed is:

1. An electronic device comprising:
a battery;
a measuring unit to record a plurality of temperature readings associated with an operation of the battery at particular time intervals;
a control unit coupled, to the measuring unit to:
retrieve a set of temperature readings corresponding to a period from the plurality of temperature readings;
analyze the set of temperature readings corresponding to the period to determine whether temperature temperature of the battery exceeds a threshold; and
reduce a charging voltage of the battery in response to a determination that the temperature of the battery exceeds the threshold.

2. The electronic device of claim 1, wherein the control unit, is to:
determine an amount of time the temperature of the battery exceeds the threshold based on the analysis of the set of temperature, readings; and
reduce the charging voltage of the battery corresponding, to the determined amount of time the temperature of the battery exceeds the threshold.

3. The electronic device of claim 1, further comprising:
a charger circuit coupled to a power input and the battery, wherein the charger circuit is to convert an input power to an output power to charge the battery.

4. The electronic device of claim 3, wherein the control unit is to:
control the output power from the charger circuit to reduce the charging voltage of the battery in response to the determination that the temperature of the battery exceeds the threshold.

5. The electronic device of claim 1, wherein the measuring unit comprises:
a sensor to measure the plurality of temperature readings associated with the operation of the battery at the particular time intervals;
a memory; and
a processor to store the plurality of temperature readings in the memory.

6. An electronic device comprising:
a battery pack comprising:
a battery; and
a fuel gauge to measure a plurality of temperature readings of he battery at particular time intervals, wherein the measured plurality of temperature readings being segmented into a set of temperature ranges;
a charger circuit to charge the battery; and
a control unit communicatively coupled to the fuel gauge to:
determine an amount of time a temperature of the battery is in a first temperature range of the set of temperature ranges, wherein the first temperature range is greater than a threshold; and
reduce, via the charger circuit, a charging voltage of the battery proportional to the amount of time the temperature of the battery is in the first temperature range.

7. The electronic device of claim 6, wherein the control unit is to:
determine an amount of time the temperature of the battery is in a second temperature range of the set of temperature ranges, the second temperature range is different from the first temperature range and greater than the threshold; and
reduce the charging voltage of the battery proportional to the mount of time the temperature of the battery is in the first temperature range and the second temperature range.

8. The electronic device of claim 6, wherein the control unit is to:
determine a value of the charging voltage to be supplied to the battery based on the amount of time the temperature of the battery is in the first temperature range; and
reduce the charging voltage based on the determined value.

9. The electronic device of claim 6, wherein the fuel gauge is an integrated circuit.

10. The electronic device of claim 6, wherein the fuel gauge comprises:
a sensor to measure the plurality of temperature readings of the battery at the particular time intervals;
a memory; and
a processor to segment the measured plurality of temperature readings into the set of temperature ranges and store the segmented plurality of temperature readings in the memory.

11. A non-transitory machine-readable storage medium encoded with instructions that, when executed by an electronic device cause the electronic device to:
retrieve a set of temperature readings corresponding to a period from a battery pack, wherein the set of temperature readings falls into discrete temperature ranges;
analyze the set of temperature readings corresponding to the period;
determine an amount of time a temperature of the battery pack is in a first temperature range of the discrete temperature ranges based on the analysis, wherein the first temperature range is greater than a threshold; and,
generate an option to reduce a charging voltage of the battery pack on a display unit in response to determining the amount of time the temperature of the battery pack is in the first temperature range.

12. The non-transitory machine-readable storage medium of claim her comprising instructions to:
reduce the charging voltage of the battery pack in response to a selection of the option.

13. The non-transitory machine-readable storage medium of claim 12, wherein instructions to reduce the charging voltage of the battery pack comprises:
instructions to reduce the charging voltage of the battery Pack corresponding to the determined amount of time the temperature of the battery pack is in the first temperature range by generating a command to a charger circuit that supplies the charging voltage to the battery pack.

14. The non-transitory machine-readable storage medium of claim 11, further comprising instructions to:
monitor and store a plurality of temperature readings associated with an operation of the battery pack at particular time intervals via a fuel gauge resided in the battery pack, wherein the set of temperature readings corresponding to the period may be retrieved from the plurality of temperature readings.

15. The non-transitory machine-readable storage medium of claim 11, wherein instructions to generate the option comprises instructions to:
determine a value of the charging voltage to be supplied to the battery pack based on the amount of time the temperature of the battery pack is in the first temperature range; and
generate the option including the determined value on the display unit.
